(19) United States
(12) Patent Application Publication
(10) Pub. No.: US 2018/0149766 A1
(43) Pub. Date: May 31, 2018

(54) X-RAY SCANNING FOR INSPECTION OF PACKAGES ON GROUND

(71) Applicant: SATPAL SINGH, Potomac, MD (US)

(72) Inventor: SATPAL SINGH, Potomac, MD (US)

(21) Appl. No.: 15/365,220

(22) Filed: Nov. 30, 2016

(51) Int. Cl. G01V 5/00; G01N 23/04

(52) U.S. Cl. CPC G01V 5/0066; G01N 23/04

(57) ABSTRACT

A portable scanner is presented that is especially suited for x-ray inspection of packages that are left behind on rough terrain. An x-ray source and a linear detector are used to implement a transmissive x-ray imaging of an object or a package. A special feature of this invention is that the linear detector is first placed horizontally on the ground or the rough terrain and vertically moved upwards to implement the scan. The detector may be moved upwards either in an angular movement or in a linear motion.

### BACKGROUND OF THE INVENTION

A portable scanner especially suited for x-ray inspection of packages that are left behind on rough terrain is described.

### DESCRIPTION OF THE RELATED ART

U.S. Pat. No. 8,734,013 B2 to Singh and US patent application US 2016/0170076 A1 by Singh describe small mobile x-ray scanning systems for inspection of packages left in buildings or outdoors. Both these systems have a linear detector that is essentially arranged vertical and during the scan stays vertical with the bottom end of the detector held close to the ground or the bottom of the object that is being scanned. The problem with these systems is that on rough terrain, the bottom of the detector scrapes the ground and shakes causing distortion in the scanned image that shows a wavy image. Worse problem arises when the bottom of the detector gets stuck on rough terrain as in outdoors on uneven pavement or in grass or bushes causing to abort the scan. It is therefore

The objects of this invention are therefore to overcome the aforementioned problem and are listed next.

### Objects and Advantages of the Invention

It is, accordingly, an object of the invention to develop a portable inspection system suitable for inspection of leave behind packages and capable of producing high fidelity images even if the object is placed on a rough terrain.

There are several embodiments and advantages that will become apparent in the description that follows.

### SUMMARY OF THE INVENTION

In accordance with one embodiment, a portable scanner is presented that is especially suited for x-ray inspection of packages that are left behind on rough terrain. An x-ray source and a linear detector are used to implement a transmissive x-ray imaging of an object or a package. A special feature of this invention is that the detector is first placed horizontally on the ground or the rough terrain and vertically moved upwards to implement the scan. The detector may be moved upwards either in an angular movement or in a linear motion.

In the first embodiment of the invention a linear detector is supported at a predetermined distance from the radiation or an X-ray source. The linear detector is connected to the X-ray source by a supporting mechanical link. The linear detector is oriented horizontally and is positioned initially close to the bottom of the object to be scanned or it may be made to rest on the ground. To implement the scan, the source is rotated such that the mechanical link connected to the detector lifts the detector upwards. As the detector moves vertically upwards, the radiation path from the source to the detector intercepts the object at different heights thereby scanning the object from bottom to the top. As is well known to a person skilled in the art, as the detector moves up, the sensor or detector signal is processed and displayed on a screen line by line to generate a scanned X-ray image.

In an alternate embodiment, the source is not rotated but moved linearly upwards. As the source moves up, the mechanical link connecting the source to the detector lifts the detector upwards. As the detector moves up, the detector signal is processed and displayed line by line on a screen to display a scanned X-ray image.

In an alternate embodiment, the mechanical link connecting the source and the detector is essentially horizontal, so that it goes around the object to be scanned rather than over it. This arrangement of the mechanical link is especially useful if tall objects have to be scanned.

In other embodiments, the above described embodiments may be mounted on a mobile platform.

There are several embodiments, objects and advantages to this invention that will be apparent to one skilled in the art. The accompanying figures and description herein should be considered illustrative only and not limiting or restricting the scope of invention, the scope being indicated by the claims.

### BRIEF DESCRIPTION OF THE DRAWINGS

FIG. 1 shows one embodiment of the invention where the detector 40 is placed horizontally against the ground.

FIG. 2 demonstrates the operation of the invention. FIG. 2A shows the starting position of the scan with the detector 40 positioned horizontally such that the radiation beam 32 intercepts the object 50 at the bottom or passes below the bottom of said object. FIG. 2B shows an interim position of the detector 40 at about mid way into the scan. The source 30 along with detector 40 are rotated as indicated by arrow 60 such that the radiation beam 32 is angled upwards to intercept the object 50 during the scan. FIG. 2C shows the end position of detector 40 attained after further rotation as indicated by arrow 60. At this end position of the scan, the radiation beam 32 clears the top of the object 50.

FIG. 3 shows an alternate embodiment of the invention wherein the x-ray system of FIG. 1 is mounted on a mobile platform 70.

FIG. 4 shows another embodiment where the source 30 and detector 40 are mounted on a mobile platform 70 and are moved linearly in the vertical direction upwards to scan the object rather than the rotational movement depicted in FIGS. 2 and 3. FIG. 4A shows the starting position of the scan with the detector 40 positioned horizontally such that the radiation beam 32 intercepts the object 50 at the bottom or passes below the bottom of said object. FIG. 4B shows an interim position of the detector 40 at about mid way into the scan. The source 30 along with detector 40 are being translated vertically upwards as indicated by arrow 62. FIG. 4C shows the position of detector 40 at the end of the scan. At this end position of the scan, the radiation beam 32 clears the top of the object 50.

FIG. 5 shows another embodiment of the invention where the detector 40 is connected the source 30 by mechanical link 41 that is essentially horizontal and is positioned around the object 50 instead of going over the top as shown in FIGS. 1-4. The position of the detector 40 at the start of scan is shown in FIG. 5A. FIG. 5B shows the midway position of the detector and FIG. 5C shows the position of the detector at the end of the scan.

### DETAILED DESCRIPTION OF THE PREFERRED EMBODIMENTS

In describing the first embodiment and its alternatives, specific terminology will be used for the sake of clarity. However, the invention is not limited to the specific terms so used, and it should be understood that each specific term includes all its technical equivalents which operate in a similar manner to accomplish similar purpose.

This invention describes a portable X-ray scanner that is especially suited for inspection of packages that are left behind on rough terrain. An x-ray source and a detector are used to implement a transmissive x-ray imaging of an object or a package. A special feature of this invention is that the detector is first placed horizontally on the ground or the rough terrain and vertically moved upwards to implement the scan. It is not necessary to move the detector up to scan, instead the detector could be moved down from a higher position to the ground.

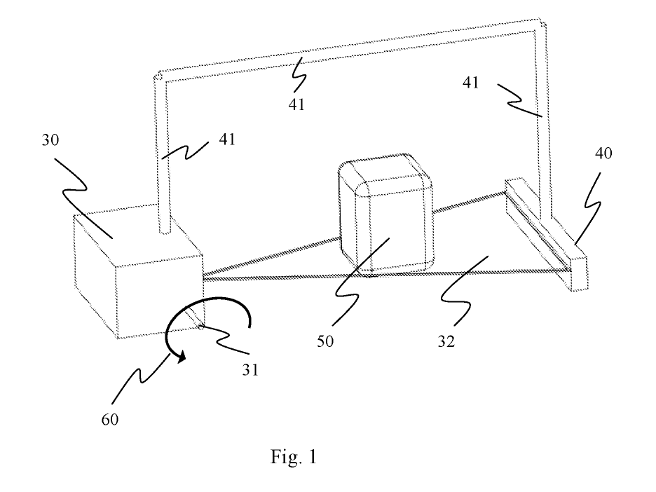

A simplified assembly of one or the first embodiment is shown in FIG. 1. To have a clarity in the drawings and to maintain focus on the essence of this invention, overcrowding or clutter in the drawings is avoided and only the components important to the description of the invention are shown. Therefore there are several components and subsystems not shown but are well known to a person skilled in the art.

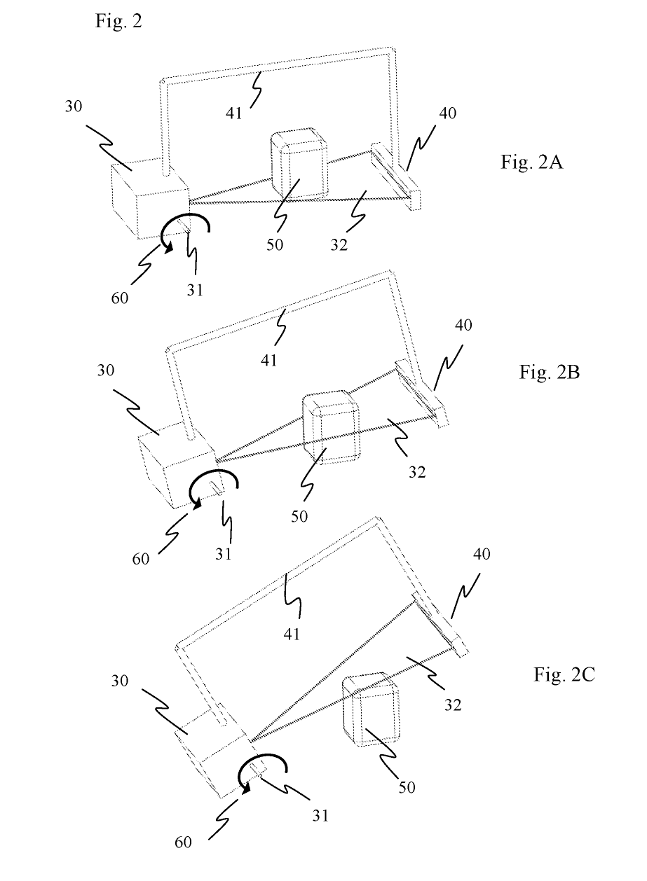

Shown in FIG. 1 is an X-ray source 30. This may be an X-ray source or some other suitable radiation source as is well known to person skilled in the art. This radiation source emits a radiation beam 32. A linear detector or sensor 40 is placed horizontally opposing the radiation or the x-ray source such that the radiation beam 32 impinges or illuminates the detector. The detector is connected to the source 30 by a rigid mechanical member or link 41 which is generally “C” or “U” shaped as shown. However, the link 41 could be any means suitable to position the detector 40 at a predetermined distance from the source 30. Connected to the source 30 is a shaft 31 such that rotating this shaft rotates the source. The object 50 to be scanned is shown interposed between the source 30 and detector 40. The scanning is accomplished by rotating the source 30 about the axis of the shaft 31 as indicated by arrow 60. A more detailed operation of the system is described with reference to FIG. 2.

FIG. 2A shows the detector position at the start of the scan. In this position, the detector 40 is resting on the ground or positioned such that the radiation beam 32 from source to detector 40 passes through the bottom or below the bottom of object 50. The scan operation is started by rotating the source 30 about the axis of shaft 31 as indicated by arrow 60. An interim position during the scan is shown in FIG. 2B. Since the detector 40 is rigidly connected to the source 30 via mechanical link 41, the rotation of source 30 now lifts the detector 40 vertically upwards.

The radiation beam 32 from the source 30 to detector 40 now intercepts the object 50 at approximately half the height of the object. Further rotating the source as indicated by arrow 60 further lifts the detector 40 vertically upwards. FIG. 2C shows the position of the detector 40 at the end of the scan. At this position, the radiation beam 32 passes above the object 50.

As is well known to the person skilled in the art, the signal from the detector 40 can be processed electronically and using a computing means can be displayed line by line horizontally stacked on a screen to display the scanned image.

It should be noted that any rotational means can be used that is suitable to change the vertical height of said detector 40 to implement the scan illustrated in FIG. 2.

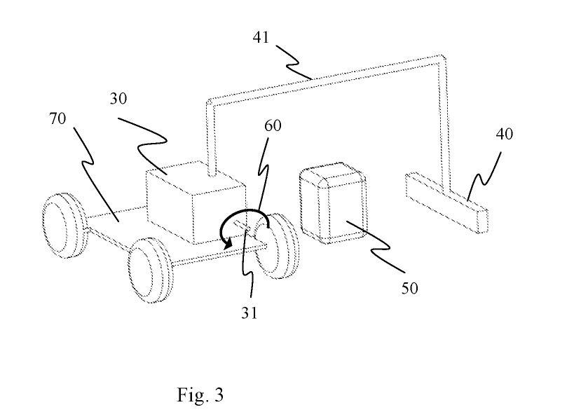

An alternate embodiment of the invention is shown in FIG. 3 wherein the x-ray system of FIG. 1 is mounted on a mobile platform 70.

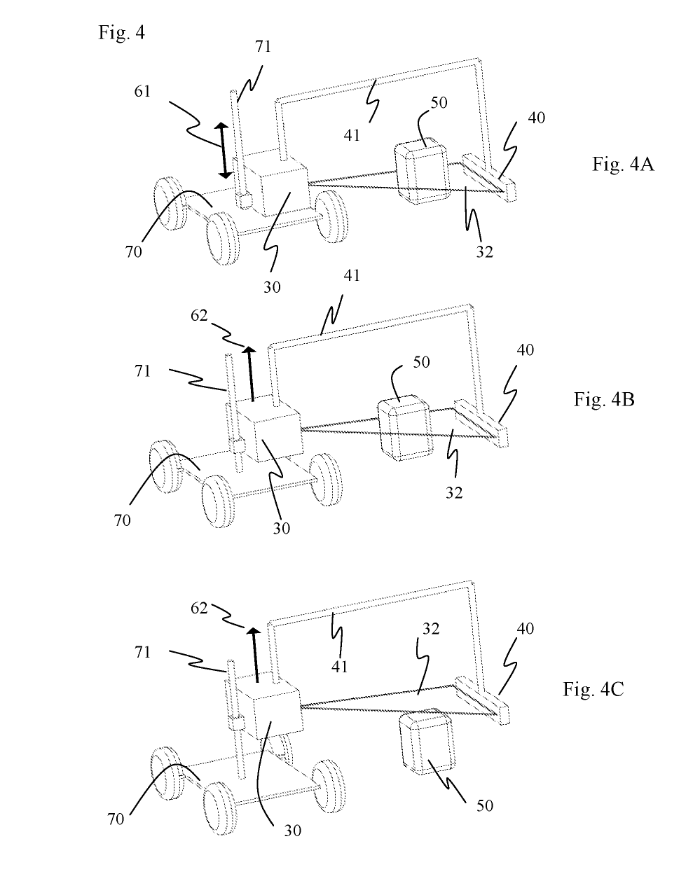

FIG. 4 shows another embodiment wherein the source 30 and detector 40 are mounted on a mobile platform 70 and are moved linearly in the vertical direction upwards to scan the object rather than the rotational movement depicted in FIGS. 2 and 3. The source 30 is mounted on a vertical member or link 71. Further, the source 30 can slide up and down the vertical member 71 as indicated by up down arrow 61.

It should be noted that to implement the scan illustrated in FIG. 4, any means to linearly translate in essentially vertical direction can be used to change the vertical height of detector 40.

FIG. 4A shows the starting position of the scan with the detector 40 positioned horizontally such that the radiation beam 32 intercepts the object 50 at the bottom or passes below the bottom of said object. The source 30 is then linearly translated upwards as indicated by the up arrow 62 in FIG. 4B which shows an interim position of the detector 40 at about mid way into the scan. The source 30 along with detector 40 are further translated vertically upwards as indicated by up arrow 62. FIG. 4C shows the position of detector 40 at the end of the scan. At this end position of the scan, the radiation beam 32 clears the top of the object 50.

It should be noted that the scanning in FIGS. 1-3 is implemented by a rotational movement and may be referred to as a rotational scan while the scanning of FIG. 4 may be referred to as a linear scan.

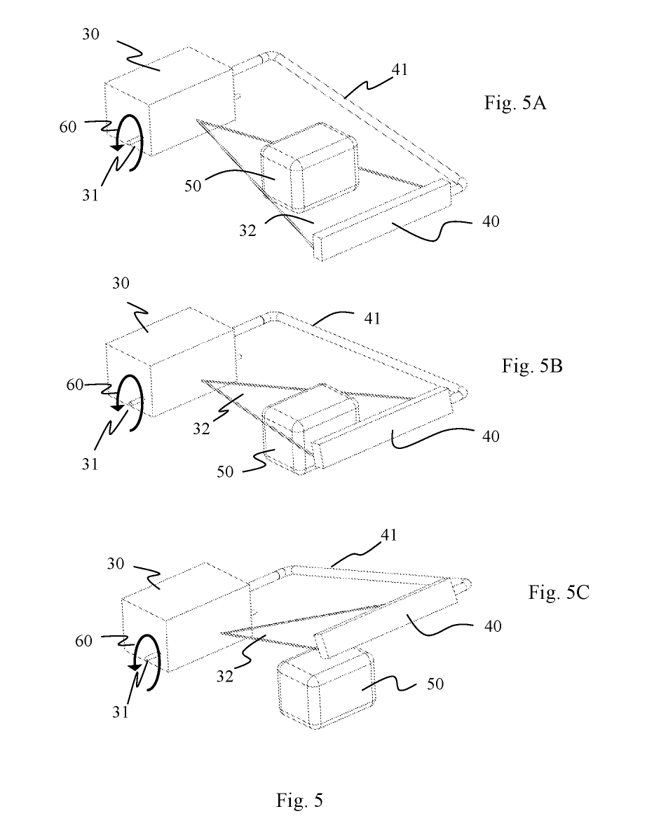

FIG. 5 shows another embodiment of the invention wherein the detector 40 is connected the source 30 by mechanical link 41 that is essentially horizontal and is positioned around the object 50 instead of going over the top as shown in FIGS. 1-4. The scanning is accomplished by rotating the source about the axis of shaft 31 as indicated by arrow 60 and already described with reference to FIG. 1 and FIG. 2. The position of the detector 40 at the start of scan is shown in FIG. 5A. FIG. 5B shows the midway position of the detector and FIG. 5C shows the position of the detector at the end of the scan.

In yet another embodiment of the invention, the configuration of FIG. 5 can be displaced vertically upwards in a linear fashion similar to that described with reference to FIG. 4.

In alternate embodiment of the invention, the source 30 emits a conical radiation beam rather than a flat fan beam depicted in FIGS. 1-5. The detector 40 is not rigidly connected to the source 30 via the mechanical link 41. During the scan, the source 30 is held stationary, it is neither rotated nor moved linearly upwards. Only the detector is rotated to follow a trajectory similar to that of FIG. 2 or linearly translated upwards to achieve a detector trajectory similar to that of FIG. 4.

As is well known to a person skilled in the art, the linear detector has multiple sensors arranged along a straight line. However in the description of the invention above, it is not necessary for the detectors to be arranged in a straight line. Further, the detector may be two dimensional with multiple rows of sensors similar to the arrangement used for time delay integration techniques. It should be noted that a sufficient requirement for the detector is to have one dimension of predetermined length that can be oriented essentially horizontally.

In the preceding description of the various embodiments, the electronic and computing means to process the detector signal and generate a scanned image have been omitted as they are well known to a person skilled in the art.

The foregoing description of the invention and its embodiments should be considered as illustrative only of the concept and principles of the invention. The invention may be configured in a variety of ways, shapes and sizes and is not limited to the description above. Numerous applications of the present invention will readily occur to those skilled in the art. Therefore, it is desired that the scope of the present invention not be limited by the description above but by the claims presented herein.

The invention claimed is:

1. A portable device suited for inspection of an object comprising of:
a radiation source emitting a radiation beam;
a radiation detector to detect said radiation beam, further said detector having a predetermined linear dimension;
a means to position said radiation detector at a predetermined distance from said radiation source such that said linear dimension of said detector is essentially horizontal;
a means to position said radiation source and said radiation detector such that said object is positioned between said radiation source and said radiation detector;
a means to change the vertical height of said detector such that said radiation beam intercepts said object at different heights; and
a computing means to analyze the data from said detector.

2. The device of claim 1 wherein said means to change the vertical height of said detector further comprises of a means to rotate said detector.

3. The device of claim 1 wherein said means to change the vertical height of said detector further comprises of a means to linearly translate said detector in essentially vertical direction.

4. A method suited for inspection of an object comprising of:
using a radiation source to emit a radiation beam;
using a radiation detector to detect said radiation beam, further said detector having a predetermined linear dimension;
using a means to position said radiation detector at a predetermined distance from said radiation source such that said linear dimension of said detector is essentially horizontal;
using a means to position said radiation source and said radiation detector such that said object is positioned between said radiation source and said radiation detector;
using a means to change the vertical height of said detector such that said radiation beam intercepts said object at different heights; and
using a computing means to analyze the data from said detector.

5. The method of claim 4 wherein the step of using said means to change the vertical height of said detector further comprises of using a means to rotate said detector.

6. The device of claim 4 wherein the step of using said means to change the vertical height of said detector further comprises of using a means to linearly translate said detector in essentially vertical direction.
